(19) United States
(12) Patent Application Publication
(10) Pub. No.: US 2006/0216550 A1
(43) Pub. Date: Sep. 28, 2006

(54) Method of manufacturing master disk for magnetic transfer, master disk for magnetic transfer, and magnetic recording medium

(75) Inventor: Seiji Kasahara, Odawara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/385,702

(22) Filed: Mar. 22, 2006

(30) Foreign Application Priority Data
Mar. 23, 2005 (JP) 2005-084563

(51) Int. Cl. G11B 5/64; B05D 5/12

(52) U.S. Cl. 428/826; 428/836; 427/127

(57) ABSTRACT

The present invention provides a method of manufacturing a master disk for magnetic transfer, comprising the steps of: forming a metal plate having a predetermined thickness on an original plate having a concavo-convex pattern corresponding to information to be transferred; stamping the metal plate separated from the original plate to form a center opening and a circular rim, thereby providing a master substrate; and depositing a magnetic layer on the concavo-convex pattern of the master substrate, wherein a region at the upper edge of the center opening where a roll off occurs when the center opening of the master substrate is formed by stamping is defined as a center-opening roll-off region, a predetermined range of center-opening buffer region is provided outside of the center-opening roll-off region, and the concavo-convex pattern is formed outside of the center-opening buffer region.

### BACKGROUND OF THE INVENTION

1. Field of the Invention

The present invention relates to a method of manufacturing a master disk for magnetic transfer, a master disk for magnetic transfer and a magnetic recording medium. In particular, it relates to a method of manufacturing a master disk for magnetic transfer that is suitable for transferring magnetic information, such as format information, to a magnetic recording medium used in a hard disk device or the like, a master disk for magnetic transfer, and a magnetic recording medium.

2. Description of the Related Art

In a magnetic disk (hard disk) used in a hard disk drive rapidly diffused recently, format information or address information are written, generally, after it is delivered from a magnetic disk maker to a drive maker and before it is assembled to the drive. The writing can be performed by a magnetic head, but a method for transferring the information collectively from a master disk in which the format information or the address information is written, is effective and preferable.

In the one-time magnetic transfer process, a master disk for magnetic transfer (sometimes referred to simply as master disk, hereinafter) and a transfer-target disk (sometimes referred to as magnetic recording medium or slave disk, hereinafter) are brought into close contact with each other, a magnetic field generating device, such as an electromagnet device and a permanent magnet device, is disposed on either or both sides of the resulting disk stack to apply a transfer magnetic field thereto, thereby magnetically transferring the information (servo signals, for example) recorded on the master disk to the slave disk. To achieve the magnetic transfer with high accuracy, it is extremely important to bring the master disk and the slave disk into close contact with each other uniformly without a clearance.

As the master disk used for the method for magnetic transfer, a disk in which a concavo-convex pattern corresponding to information signal is formed on the substrate surface, and a magnetic layer is coated on the surface of the concavo-convex pattern, is generally used. The master disk for magnetic transfer is generally manufactured by coating a magnetic layer on the surface of the concavo-convex pattern, after the steps of: electroforming on an original plate in which information is formed with the concavo-convex pattern, and for laminating a metal disk made of the electroformed layer on the original plate to transfer the concavo-convex pattern on the metal disk; releasing the metal disk from the original plate; and punching through the released metal disk in a predetermined size (for example, see Japanese Patent Application Laid-Open No. 2001-256644).

### SUMMARY OF THE INVENTION

In the stamping step described above, a stamping tool having a pair of a stationary blade and a movable blade is used to stamp the metal plate to form a center opening and a circular outer rim. In the areas where the center opening and the outer rim are formed, a roll off occurs on the side of the master substrate into which the movable blade cuts, and a burr occurs on the side thereof from which the movable blade emerges.

FIG. 9 is a conceptual diagram showing a metal plate, which is an original plate of a master substrate, in which a center opening is being formed by stamping using a stationary blade 42 and a movable blade 45. As shown in FIG. 9, a center-opening movable blade 45a is pressed into the front surface of an original plate 11′ to form a center opening. During this process, a roll-off part (sometimes referred to simply as roll off) DA occurs on the front side of the original plate 11′ due to plastic deformation, and a burr BA occurs on the back side thereof due to plastic fracture. FIG. 9 is only a conceptual diagram, and for clearness of the burr BA, the original plate 11′ and the movable die 45 are shown by design as being vertically displaced.

The size of the roll-off part DA due to plastic deformation and the burr BA depends on the value of the clearance C between a center-opening stationary blade 42a and the center-opening movable blade 45a. The smallest possible value of the clearance C is not the most preferable, and the height of the burr BA increases if the value of the clearance C becomes too small.

In general, punching of a metal plate is considered high quality if the height of the burr BA occurring at the area stamped with a stamping tool is generally equal to or less than 0.1 mm. However, as for the master disk 11 of the master disk for magnetic transfer, even a burr BA of a height of about 5 μm degrades the contact between the master disk and the slave disk during magnetic transfer, and there is a problem that the spacing between the master disk and the slave disk reduces the intensity of the transferred signals, and the magnetic transfer cannot be achieved adequately.

To enhance the contact between the master disk and the slave disk, the contact pressure between the two can be raised. However, raising the contact pressure may cause breakage or deformation of the concavo-convex pattern formed on the master disk and, therefore, may cause degradation of the durability of the master disk.

Therefore, a metal plate is stamped into a predetermined shape by pressing the movable blade of the stamping tool, which comprises the stationary blade and the movable blade, into the metal plate from the front surface on which the concavo-convex pattern is formed to the back surface.

Thus, the burr BA, which occurs at the stamped area, occurs on the back surface of the master substrate 11. In other words, no unwanted projections occur on the surface that is brought into contact with the slave disk. In addition, after the stamping step, the burr can be removed by polishing the back surface of the master substrate 11.

However, in a region close to the roll-off part DA occurring on the front surface of the master disk 11, a slight clearance occurs between the master disk and the slave disk in contact with each other. As a result, there is a problem that the magnetic transfer cannot be achieved adequately, for example, the signals magnetically transferred to the slave disk are reduced.

This phenomenon is more noticeable in a region close to the inner rim of the master substrate 11 where the size of the concavo-convex pattern is smaller (that is, a region close to the center opening) than in a region close to the outer rim of the master substrate 11. In the case of a master disk comprising a master substrate having a concavo-convex pattern whose minimum pattern size is equal to or less than 100 nm, in particular, the contact between the master disk and the slave disk, which is the target of magnetic transfer, is extremely important.

The present invention has been devised in view of such circumstances, and an object of the present invention is to provide a method of manufacturing a master disk for magnetic transfer that involves fabricating a master substrate in a predetermined shape by stamping a metal plate having a concavo-convex pattern corresponding to an information signal and suppresses degradation of transfer characteristics due to a roll off that occurs on the front surface of the master substrate during stamping, thereby allowing adequate magnetic transfer, a master disk for magnetic transfer, and a magnetic recording medium to which pre-format information is adequately magnetically transferred.

In order to attain the object described above, according to a first aspect of the present invention, there is provided a method of manufacturing a master disk for magnetic transfer, comprising the steps of: forming a metal plate having a predetermined thickness on an original plate having a concavo-convex pattern corresponding to information to be transferred; stamping the metal plate separated from the original plate to form a center opening and a circular rim, thereby providing a master substrate; and depositing a magnetic layer on the concavo-convex pattern of the master substrate, in which a region at the upper edge of the center opening where a roll off occurs when the center opening of the master substrate is formed by stamping is defined as a center-opening roll-off region, a predetermined range of center-opening buffer region is provided at the outer side of the surface of the master substrate relative to the center-opening roll-off region, and the concavo-convex pattern is formed at the outer side of the surface of the master substrate relative to the center-opening buffer region. According to the first aspect of the present invention, since a center-opening buffer region is formed outside of the region where a roll off occurs at the center opening of the master substrate, and the concavo-convex pattern is formed outside of the center-opening buffer region, the region close to the roll-off region at the center opening where magnetic transfer is unstable is not used, and only a stable region is used. Therefore, a master disk for magnetic transfer that can provide adequate magnetic transfer is obtained.

According to a second aspect of the present invention, in the first aspect of the present invention, a region at the upper edge of the outer rim where a roll off occurs when the outer rim of the master substrate is formed by stamping is defined as an outer-rim roll-off region, a predetermined range of outer-rim buffer region is provided inside of the circle shaped with the outer-rim roll-off region, and the concavo-convex pattern is formed inside of the circle shaped with the outer-rim buffer region.

According to the second aspect of the present invention, since an outer-rim buffer region is formed at the inner side of the surface of the master substrate relative to the region where a roll off occurs at the outer rim of the master substrate, and the concavo-convex pattern is formed at the inner side of the surface of the master substrate relative to the outer-rim buffer region, the region close to the roll-off part at the outer rim where magnetic transfer is unstable is not used, and only a stable region is used. Therefore, a master disk for magnetic transfer that can provide adequate magnetic transfer is obtained.

According to a third aspect of the present invention, in the first or second aspect of the present invention, the outer radius of the center-opening buffer region from the center of the center opening is defined as a numeric value, which is the radius of the center opening multiplied by a predetermined coefficient.

According to the third aspect of the present invention, since the outer radius of the center-opening buffer region from the center of the center opening is defined as a numeric value, which is the radius of the center opening multiplied by a predetermined coefficient, by appropriately setting the coefficient, the center-opening buffer region can be made as narrow as possible, thereby achieving adequate magnetic transfer, while appropriately assuring a required recording density of information signals.

Furthermore, according to a fourth aspect of the present invention, in the third aspect of the present invention, the predetermined coefficient for determining the outer radius of the center-opening buffer region preferably has an upper limit and a lower limit.

According to a fifth aspect of the present invention, in any one of the second, third and fourth aspects of the present invention, the inner radius of the outer-rim buffer region from the center of the center opening is defined as a numeric value, which is the outer radius of the master substrate multiplied by a predetermined coefficient.

According to the fifth aspect of the present invention, since the inner radius of the outer-rim buffer region from the center of the center opening is defined as a numeric value, which is the outer radius of the master substrate multiplied by a predetermined coefficient, by appropriately setting the coefficient, the outer-rim buffer region can be made as narrow as possible, thereby achieving adequate magnetic transfer, while appropriately assuring a required recording density of information signals.

Furthermore, according to a sixth aspect of the present invention, in the fifth aspect of the present invention, the predetermine~d coefficient for determining the inner radius of the outer-rim buffer region preferably has an upper limit and a lower limit.

A master disk for magnetic transfer according to a seventh aspect of the present invention is manufactured by a method of manufacturing a master disk for magnetic transfer according to any one of the first to sixth aspects of the present invention described above.

According to the seventh aspect of the present invention, since the master disk for magnetic transfer according to the present invention has a concavo-convex pattern in an region where the concavo-convex pattern is not affected by a roll off that occurs during stamping, the contact between the information bearing surface and the slave disk is improved, and adequate magnetic transfer can be achieved.

A magnetic recording medium according to an eighth aspect of the present invention has pre-format information magnetically transferred from a master disk for magnetic transfer according to the seventh aspect of the present invention.

According to the eighth aspect of the present invention, since the magnetic recording medium according to the present invention has information accurately magnetically transferred from a master disk for magnetic transfer that has an information bearing surface that is in good contact with the magnetic recording medium, the pre-format information signal of high quality can be obtained.

As described above, in the method of manufacturing a master disk for magnetic transfer, the master disk for magnetic transfer and the magnetic recording medium according to the present invention, since a center-opening buffer region is formed at the outer side of the surface of the master substrate relative to the region where a roll off occurs at the center opening of the master substrate, and the concavo-convex pattern is formed at the outer side of the surface of the master substrate relative to the center-opening buffer region, the region close to the roll-off part at the center opening where magnetic transfer is unstable is not used, and only a stable region is used. Therefore, a master disk for magnetic transfer that can provide adequate magnetic transfer is obtained.

In addition, since the magnetic recording medium has pre-format information magnetically recorded thereon using the master disk for magnetic transfer manufactured by the manufacturing method described above, the pre-format information signal of high quality can be obtained.

### BRIEF DESCRIPTION OF THE DRAWINGS

FIG. 1 is a partial schematic view of a master disk;

FIG. 2 is a cross-sectional view taken along the line A-A in FIG. 1;

FIG. 3 is a plan view of a master substrate;

FIGS. 4A to 4E are process diagrams for illustrating a method of manufacturing the master disk;

FIG. 5 is a cross-sectional view of the master substrate manufactured by the method of manufacturing the master disk for magnetic transfer according to the present invention;

FIG. 6 is a perspective view showing essential parts of a magnetic transfer apparatus;

FIGS. 7A to 7C are process diagrams for illustrating essential steps of a magnetic transfer method;

FIG. 8 shows a list of practical examples; and

FIG. 9 is a conceptual diagram for illustrating occurrence of a roll off and a burr.

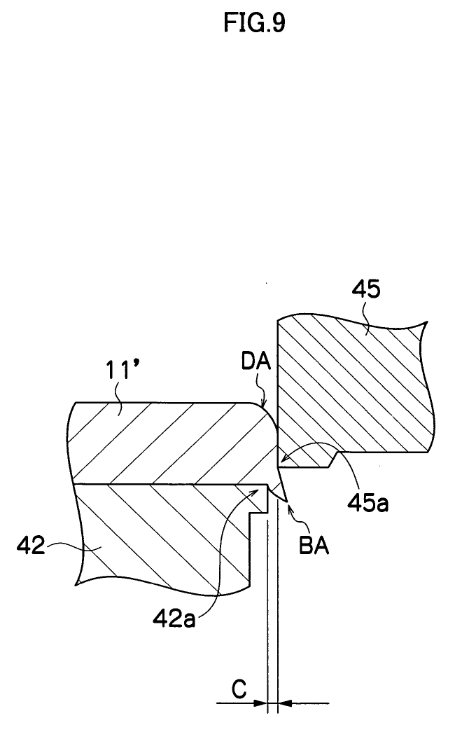

### DETAILED DESCRIPTION OF THE PREFERRED EMBODIMENTS

In the following, with reference to the accompanying drawings, a method of manufacturing a master disk for magnetic transfer, a master disk for magnetic transfer and a magnetic recording medium according to preferred embodiments of the present invention will be described.

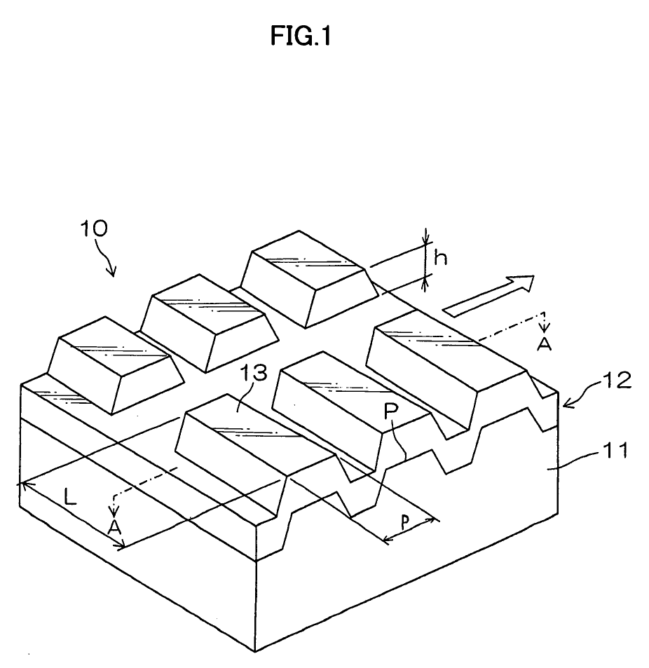

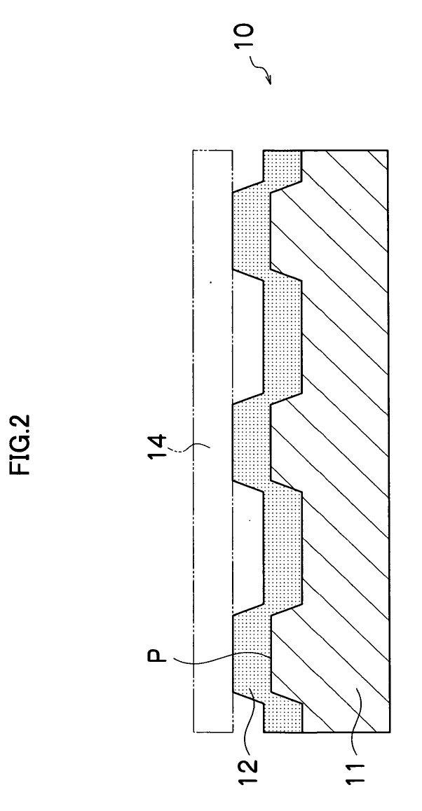

FIG. 1 is a partial perspective view of a master disk 10 for magnetic transfer (sometimes referred to simply as master disk 10, hereinafter). FIG. 2 is a cross-sectional view taken along the line A-A in FIG. 1, in which an imaginary line shows a transfer-target disk (slave disk 14), which is a magnetic recording medium.

As shown in FIGS. 1 and 2, the master disk 10 is composed of a master substrate 11 made of metal and a magnetic layer 12. The master substrate 1 1 has a fine concavo-convex pattern P that corresponds to information to be transferred (servo information pattern, for example) formed on a surface thereof, and the concavo-convex pattern P is covered with the magnetic layer 12.

In this way, an information bearing surface 13 that has the fine concavo-convex pattern P covered with the magnetic layer 12 is formed on one side of the master substrate 11. As can be seen from FIG. 1, in plan view, each projection of the fine pattern P is rectangular and has a length of p in the tracking direction (indicated by the arrow in FIG. 1) and a length of L in the radial direction, with the magnetic layer 12 formed thereon.

The optimal values of the lengths p and L depend on the recording density, the recording signal waveform or the like. For example, the length p may be 80 nm, and the length L may be 200 nm. In the case of servo signals, the projections of the fine pattern P are formed with the longer sides aligned with the radial direction. In this case, for example, it is preferred that the length L in the radial direction falls within a range from 0.05 μm to 20 μm, and the length p in the tracking direction (i.e., circumferential length) falls within a range from 0.01 μm to 5 μm.

As a pattern that bears servo signals, a pattern P is preferably used whose radial length is longer than the circumferential length, both the lengths falling within the ranges described above. The depth h of the concavo-convex pattern P (i.e., height of the projections) preferably falls within a range from 30 to 800 nm. More preferably, the depth h of the pattern P falls within a range from 50 to 300 nm.

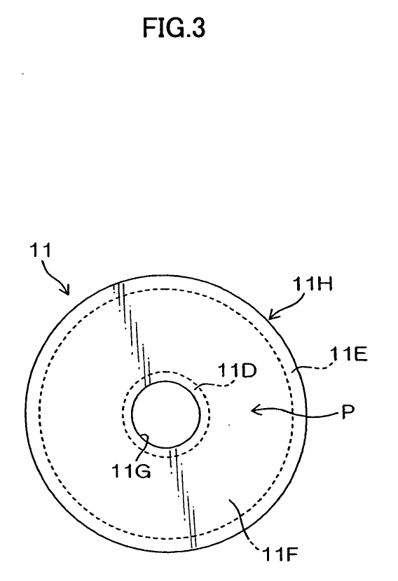

The master substrate 11 is fabricated by electroforming. As shown in FIG. 3, the master substrate 11 is disk-like and has a center opening 11G and a circular outer rim (sometimes referred to simply as outer rim, hereinafter) 11H, and the concavo-convex pattern P is formed in an annular region 11F, which is the region of one side (the information bearing surface 13) of the master substrate 11 excluding an inner peripheral region 11D and an outer peripheral region 11E.

Details of the fabrication of the master substrate 11 will be described later. In short, however, the master substrate 11 is fabricated through a process including an electroforming step of performing electroforming on an original plate that retains information in the form of a concavo-convex pattern P, thereby forming a metal plate composed of the electroformed layer on the original plate and transferring the concavo-convex pattern P onto the metal plate, a separating step of separating the metal plate from the original plate, and a stamping step of stamping the separated metal plate into a predetermined shape.

According to the present invention, various kinds of metals or alloys can be used for the electroformed layer. However, the following description of this embodiment will be made taking a Ni electroformed layer as a preferred example. To provide a flexible Ni electroformed layer, electroforming is performed by controlling the current density so that the Ni electroformed layer has a predetermined crystalline structure.

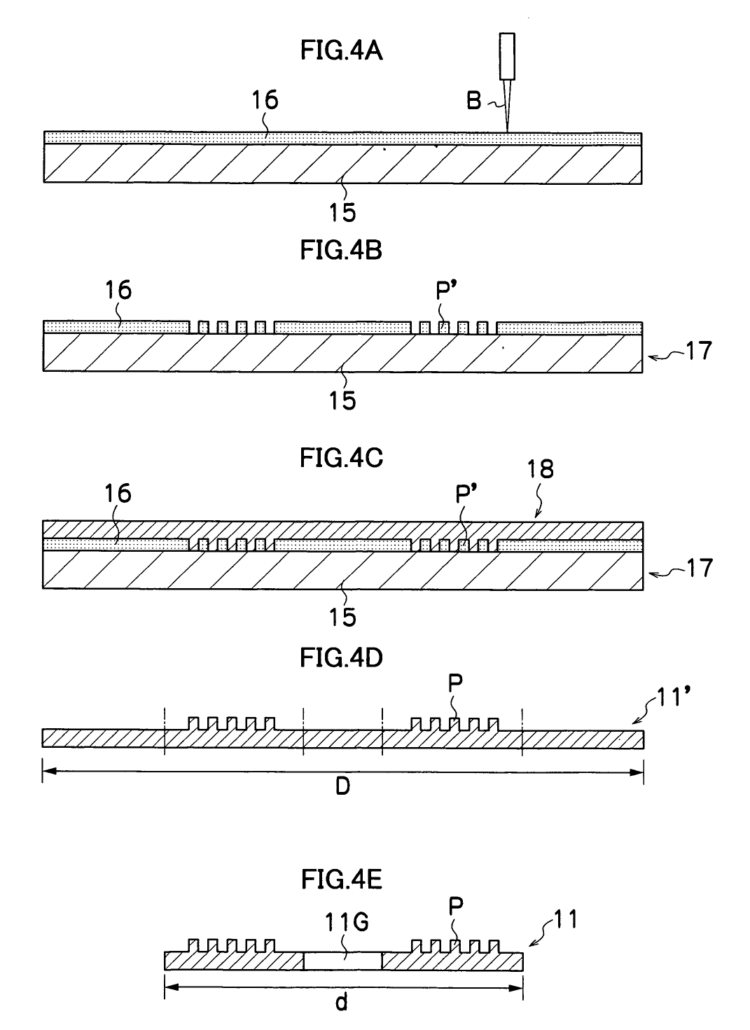

Now, a method of manufacturing the master disk 10 having a structure described above according to the present invention will be described in detail. FIGS. 4A to 4E are process charts showing steps in the manufacturing process of the master disk 10. First, as shown in FIG. 4A, a pre-processing, such as adhesion layer formation, is performed on an original plate 15, which is a silicon wafer (or glass plate or quartz plate), having a smooth and clean surface, an electron beam resist solution is applied to the surface by spin-coating or the like to form a resist film 16, and baking is performed.

Then, in an electron beam exposure system (not shown) provided with a high-precision rotating stage or X-Y stage, the original plate 15 mounted on the stage is irradiated with an electron beam B modulated according to servo signals or the like, thereby writing a desired concavo-convex pattern P′ on the resist film 16.

Then, as shown in FIG. 4B, the resist film 16 is developed, and the part exposed is removed, leaving the desired concavo-convex pattern P′ of resist film 16. Then, a Ni conductive film (not shown) is formed on the concavo-convex pattern P′ by sputtering, for example. In this way, an original plate 17 capable of being used for electroforming is fabricated.

Then, as shown in FIG. 4C, electroforming is performed on the entire surface of the original plate 17 with an electroforming apparatus, thereby depositing a metal plate 18 made of Ni metal (Ni electroformed layer) to a desired thickness. Ni has a crystalline structure of face centered cubic lattice, and the current density is controlled during electroforming to provide a predetermined crystalline structure.

According to the present invention, the deposition of the metal plate 18 by electroforming is performed to provide a flexible Ni electroformed layer with a prescribed crystalline structure. Specifically, with the original plate 17 with the Ni conductive layer immersed in a Ni electroforming bath and rotating at a speed of 50 to 150 rpm, the electroformed layer of a desired crystalline structure is formed on the original plate 17 by changing the density of the current applied to the Ni electroforming bath.

Typically, the metal used for the master disk 10 is nickel (Ni). However, in the case of manufacturing the master disk 10 by electroforming, a nickel sulfamate bath, which facilitates fabrication of the master substrate 11 having low stress, is preferably used.

For example, the nickel sulfamate bath contains 400 to 800 g/L of nickel sulfamate and 20 to 50 g/L (supersaturation) of boric acid as chief constituents and, as required, an additive, such as a surface-active agent (for example, sodium lauryl sulfate). The temperature of the plating bath is preferably 40 to 60° C. As the counter electrode for the electroforming, a nickel ball housed in a titanium casing is preferably used.

Then, the metal plate 18 is separated from the original plate 17 and cleaned to remove any remaining resist film 16. Thus, as shown in FIG. 4D, there is provided an original plate 11′ of the master substrate 11 that has a reversal concavo-convex pattern P and is yet to be stamped into a predetermined size and has an outer diameter of D.

The original plate 11′ is stamped to provide the master substrate 11 of a predetermined size, specifically, an outer diameter of d, as shown in FIG. 4E. A magnetic layer 12 is deposited on the surface of the master substrate 11 having the concavo-convex pattern, thereby finishing the master disk 10.

In another method of manufacturing the master disk 10, electroforming may be performed on the original plate 17 to fabricate a second original plate. Then, electroforming may be performed on the second original plate to fabricate a metal plate having a reversal concavo-convex pattern P, and the metal plate be stamped into a predetermined size to provide the master substrate 11.

Alternatively, electroforming may be performed on the second original plate, or a resin solution may be applied to the second original plate and made to set, thereby fabricating a third original plate. Then, electroforming may be performed on the third original plate to fabricate a metal plate 18 having a reversal concavo-convex pattern P, the metal plate 18 be separated from the third original plate and stamped into a predetermined size, thereby providing the master substrate 11. The second or third original plate can be repeatedly used to fabricate a plurality of metal plates 18.

In addition, in fabrication of the original plate, after the resist film is exposed and developed, etching may be performed to form the concavo-convex pattern P′ on the surface of the original plate, and then the resist film may be removed.

In stamping the original plate 11′ of the master substrate 11, a protective sheet is first applied to the surface of the original plate 11′ that has the concavo-convex pattern P formed thereon for protecting the surface. The protective sheet may be one available from Trylaner International under the trade name of Silitect, one available from Nitto Denko Corporation under the trade name of KL Sheet or the like. Then, the original plate 11′ is stamped into the master substrate 11 with the side having the protective sheet facing upward.

By the stamping step described above, the master substrate 11 having the concavo-convex pattern P shown in FIG. 4E is produced from the original plate 11′ of the master substrate 11 shown in FIG. 4D. In the stamping step, the original plate 11′ of the master substrate 11 is stamped from the front side having the concavo-convex pattern P to the back side. Therefore, a burr BA due to stamping occurs on the back side of the master substrate 11, and a roll-off part DA due to plastic deformation occurs on the front side of the master substrate 11.

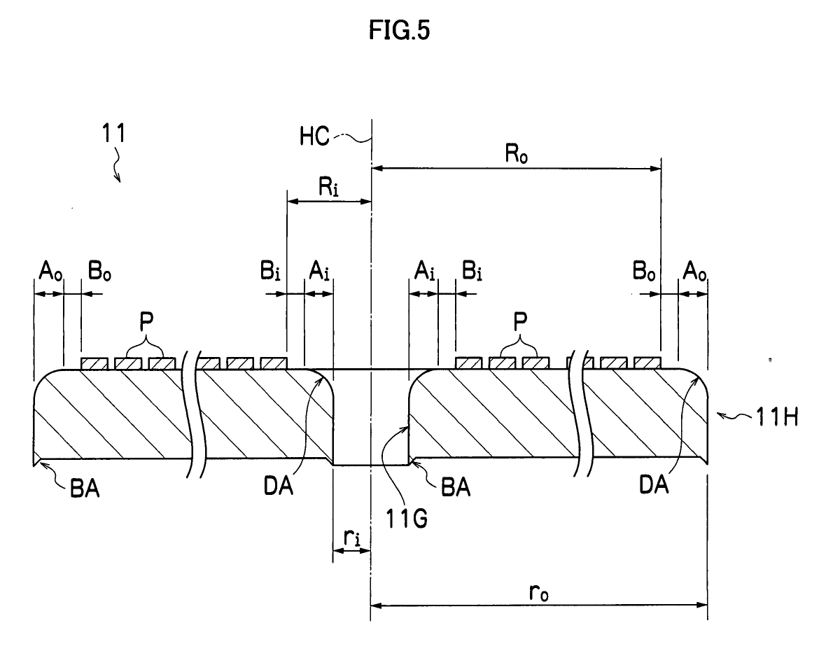

FIG. 5 shows the master substrate 11 thus stamped. As shown in FIG. 5, roll offs DA occur at the upper edges of the center opening 11G and outer rim 11H of the master substrate 11. In addition, burrs BA occur at the corresponding region on the back side thereof.

The upper edge of the center opening 11G where the roll off DA occurs is referred to as a center-opening roll-off region Ai. A center-opening buffer region Bi is defined at the outer side of the surface of the master substrate 11 relative to the center-opening roll-off region Ai, and the concavo-convex pattern P is formed at the outer side of the surface of the master substrate 11 relative to the center-opening buffer region Bi.

Furthermore, the upper edge of the outer rim 11H where the roll off DA occurs is referred to as an outer-rim roll-off region Ao. An outer-rim buffer region Bo is defined at the inner side of the surface of the master substrate 11 relative to the outer-rim roll-off region Ao, and the concavo-convex pattern P is formed at the inner side of the surface of the master substrate 11 relative to the outer-rim buffer region Bo.

When the master substrate 11 and the slave disk 14 are brought into close contact with each other, a slight clearance may occur in the vicinity of the roll-off parts DA. Thus, according to the present invention, the center-opening buffer region Bi and the outer-rim buffer region Bo are provided to allow for occurrence of such a clearance.

Specifically, the outer radius Ri of the center-opening buffer region Bi from the center HC of the center opening 11G (corresponding to the inner radius of the concavo-convex pattern P) is the radius ri of the center opening 11G multiplied by a predetermined coefficient, which depends on the dimensions of the master substrate 11.

Furthermore, the inner radius Ro of the outer-rim buffer region Bi from the center HC of the center opening 11G (corresponding to the outer radius of the concavo-convex pattern P) is the radius ro of the outer rim 11H of the master substrate 11 multiplied by a predetermined coefficient, which depends of the dimensions of the master substrate 11.

In the actual manufacturing process, during the steps of forming the concavo-convex pattern P′ on the original plate 17 as shown in FIGS. 4A and 4B, the concavo-convex pattern P′ is written and exposed to light in such a manner that the concavo-convex pattern P is formed on the master substrate 11 in the positional relationship described above.

Then, the back surface of the stamped master substrate 11 having the center opening 11G and outer rim 11H of predetermined dimensions is polished, thereby removing the burrs BA and planarizing the entire surface. As the grindstone, fixed abrasive grains of silicon carbide (SiC) or alumina (Al₂O₃) of grain sizes of #1200 and #2500 are used. The polishing step is performed under the following conditions: the type of polishing is dry polishing; the speed of rotation of the platen is 65 rpm; the speed of rotation of the work holder (that is, the speed of rotation of the master substrate 11) is 95 rpm; and the polishing pressure is 5 to 15 Psi. The polishing step is divided into two stages: coarse polishing is first performed for 25 seconds using abrasive grains of a grain size of #1200; and then, finishing polishing is performed for 25 seconds using abrasive grains of a grain size of #2500.

Once the master substrate 11 has the burrs BA on the back side removed and the entire surface planarized by the polishing step, the protective sheet on the surface thereof with the concavo-convex pattern P is peeled off, and then, the magnetic layer 12 is formed on the concavo-convex pattern P. The magnetic layer 12 is formed by depositing a magnetic material by a vacuum deposition process, such as vacuum evaporation, sputtering and ion-plating, plating, application or the like.

The magnetic material for the magnetic layer may be Co, a Co alloy (CoNi, CoNiZr, CoNbTaZr or the like), Fe, a Fe alloy (FeCo, FeCoNi, FeNiMo, FeAlSi, FeAl, FeTaN or the like), Ni or a Ni alloy (NiFe or the like). Among others, FeCo and FeCoNi are preferably used. The thickness of the magnetic layer 12 preferably falls within a range of 50 to 500 nm, and more preferably, falls within a range of 100 to 400 nm.

Furthermore, a protective film of diamond-like carbon (DLC), sputtered carbon or the like is preferably formed on the magnetic layer 12, and a lubricant layer may be formed on the protective film. In this case, a DLC film having a thickness of 3 to 30 nm as a protective film and a lubricant layer are preferably formed.

In addition, an adhesion enhancing layer of Si or the like may be formed between the magnetic layer and the protective film. The lubricant is advantageously effective for improving the durability in such a manner that it prevents a scratch from occurring during correction of misalignment between the master disk 10 and the slave disk 11 when bringing the two disks into contact with each other, for example. Through the process described above, the master disk 10 for magnetic transfer according to the present invention is manufactured.

The master disk 10 thus manufactured has the information bearing surface having the concavo-convex pattern P in a region where it is not affected by the roll offs DA that occur at the upper edges of the center opening 11G and outer rim 11H during formation of the center opening 11G and the outer rim 11H in the stamping step. Therefore, in magnetic transfer to the slave disk 14, the contact between the information bearing surface of the master substrate 11 and the magnetic layer of the slave disk 14 is improved, so that the magnetic transfer can be adequately achieved.

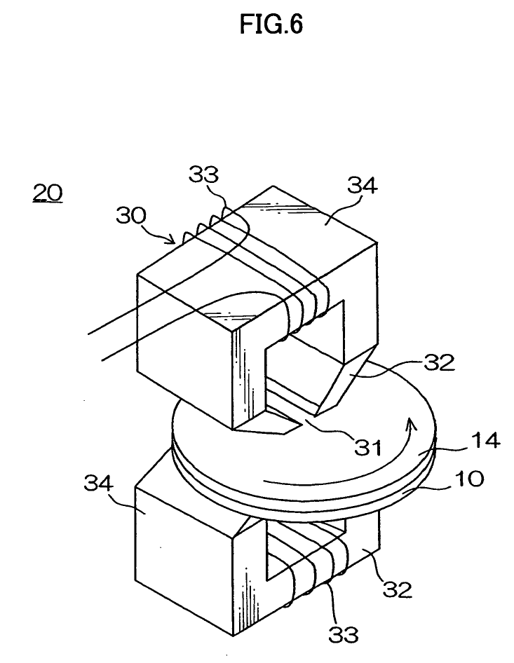

Now, a method of magnetically transferring the concavo-convex pattern P on the master disk 10 to the slave disk 14 will be described. FIG. 6 is a perspective view showing essential parts of a magnetic transfer apparatus 20 that performs magnetic transfer using the master disk 10 according to the present invention.

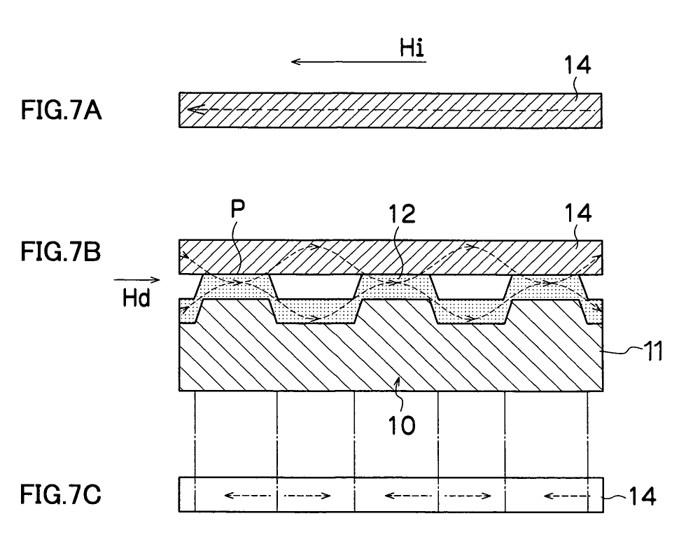

During magnetic transfer, a slave surface (magnetic recording surface) of the slave disk 14 having been subjected to initial DC magnetization shown in FIG. 7A described later is brought into close contact with the information bearing surface 13 of the master disk 10 with a predetermined pressing force. Then, with the slave disk 14 and the master disk 10 being in close contact with each other, a transfer magnetic field is applied to the disks by a magnetic field generating device 30, thereby transferring the concavo-convex pattern P on the master disk 10 to the slave disk 14.

The slave disk 14 is a disc-shaped recording medium, such as a hard disk and flexible disk having a magnetic recording layer on either or both sides thereof. Before the slave disk 14 is brought into close contact with the master disk 10, as required, cleaning (burnishing or the like) of the slave disk 14 is performed using a glide head, an abrasive material or the like to remove fine projections and dust on the surface.

As the magnetic recording layer of the slave disk 14, an applied magnetic recording layer, a plated magnetic recording layer, or a metal-thin-film magnetic recording layer may be used. As the magnetic material for the metal-thin-film magnetic recording layer, Co, a Co alloy (CoPtCr, CoCr, CoPtCrTa, CoPtCrNbTa, CoCrB, CoNi or the like), Fe, a Fe alloy (FeCo, FePt, FeCoNi or the like), Ni, and a Ni alloy (NiFe or the like) may be used.

These materials are preferred because they have a high magnetic flux density and a magnetic anisotropy in the same direction as the direction of application of the magnetic field (the in-plane direction in the case of in-plane recording), so that clear transfer can be achieved. To impart a required magnetic anisotropy below the magnetic material (on the side of the supporting base), a non-magnetic base layer is preferably formed. The base layer has to have a crystalline structure and a lattice constant adapted to the magnetic layer 12. To this end, as the material for the base layer, Cr, CrTi, CoCr, CrTa, CrMo, NiAl, Ru or the like is preferably used.

Magnetic transfer from the master disk 10 can be performed on one side of the slave disk 14 by bringing one side of the slave disk 14 into close contact with the master disk 10 or performed on both sides of the slave disk 14 by bringing the both sides of the slave disk 14 into close contact with a pair of master disks 10 disposed at the both sides of the slave disk 14.

The magnetic field generating device 30 which applies a transfer magnetic field comprises upper and lower electromagnetic devices 34 and 34 each having a core 32 and a coil 33 wound around the coil 32, and the core 32 has a gap 31 extending along the radius of the slave disk 14 and the master disk 10 held in close contact with each other. The upper and lower electromagnetic devices apply, in the same direction, transfer magnetic fields having lines of magnetic force parallel to the tracking direction.

When applying the magnetic field, the magnetic field generating device 30 applies the transfer magnetic field while the slave disk 14 and the master disk 10 integrally rotates, thereby magnetically transferring the concavo-convex pattern P on the master disk 10 to the slave surface of the slave disk 14. Alternatively, the magnetic field generating device, rather than the disks, may be rotated.

As for the transfer magnetic field, there is generated at a point along the tracking direction a magnetic field that has a magnetic field intensity distribution in which a magnetic field intensity exceeding the maximum value of an optimal transfer magnetic field intensity range (from 0.6 times higher than the coercive force Hc of the slave disk 14 to 1.3 times higher than the same) does not occur in any of the tracking directions, a magnetic field intensity falling within the optimal transfer magnetic field intensity range occurs at at least one points in one of the tracking directions, and the magnetic field intensity in the opposite tracking direction is lower than the minimum value of the optical transfer magnetic field intensity range at any point in the tracking direction.

FIGS. 7A to 7C are diagrams for illustrating essential steps of a magnetic transfer method based on in-plane recording. First, as shown in FIG. 7A, an initial magnetic field Hi is applied to the slave disk 14 in one of the tracking directions to achieve initial magnetization (DC demagnetization).

Then, as shown in FIG. 7B, the recording surface (magnetic recording region) of the slave disk 14 and the information bearing surface 13 having the concavo-convex pattern P of the master disk 10 are brought into close contact with each other, and a transfer magnetic field Hd is applied thereto in the tracking direction of the slave disk 14 opposite to that of the initial magnetic field Hi, thereby achieving magnetic transfer. The transfer magnetic field Hd is absorbed by the magnetic layer 12 of the projections of the concavo-convex pattern P, so that the magnetization is not inverted at those areas, but the magnetization is inverted at the remaining areas. As a result, as shown in FIG. 7C, the concavo-convex pattern P on the master disk 10 is magnetically transferred to and recorded on the magnetic recording surface of the slave disk 14.

In order to precisely achieve such magnetic transfer, it is important to bring the slave disk 14 and the master disk 10 into good contact with each other. By using the master disk 10 having the concavo-convex pattern P formed in a prescribed region that is manufactured by the method of manufacturing a master disk for magnetic transfer according to the present invention, a good contact between the slave disk and the master disk can be achieved, and thus the magnetic recording medium 14 of high quality is provided.

### EXAMPLES

In the following, examples will be described. Four master disks 10 having nominal sizes of 2.5 inches, 1.8 inches, 1 inch and 0.85 inches were manufactured through the process shown in FIGS. 4A to 4E described above. For the master disk 10 having a nominal size of 2.5 inches, the outer diameter ro of the master substrate 11 was 32.5 mm, and the radius ri of the center opening 11G was 10 mm.

For the master disk 10 having a nominal size of 1.8 inches, the outer diameter ro of the master substrate 11 was 24 mm, and the radius ri of the center opening 11G was 6 mm. For the master disk 10 having a nominal size of 1 inch, the outer diameter ro of the master substrate 11 was 13.6 mm, and the radius ri of the center opening 11G was 3.5 mm. For the master disk 10 having a nominal size of 0.85 inches, the outer diameter ro of the master substrate 11 was 10.8 mm, and the radius ri of the center opening 11G was 3 mm.

On the four master disks 10, the region of the concavo-convex pattern P (the region extending form the outer circumference of the center-opening buffer region Bi to the inner circumference of the outer-rim buffer region Bo) was prescribed as follows. However, this prescription may not be applied to a dummy pattern that does not contribute to the signal quality of the magnetic recording medium 14 having the concavo-convex pattern magnetically transferred.

For the master disk 10 having a nominal size of 2.5 inches, the outer radius Ri of the center-opening buffer region Bi (corresponding to the inner radius of the concavo-convex pattern P) was (radius ri of the center opening 11G) multiplied by (1.03 to 1.45), and the inner radius Ro of the outer-rim buffer region Bo (corresponding to the outer radius of the concavo-convex pattern P) was (outer radius ro of the master substrate 11) multiplied by (0.98 to 0.90).

For the master disk 10 having a nominal size of 1.8 inches, the outer radius Ri of the center-opening buffer region Bi (corresponding to the inner radius of the concavo-convex pattern P) was (radius ri of the center opening 11G) multiplied by (1.03 to 1.40), and the inner radius Ro of the outer-rim buffer region Bo (corresponding to the outer radius of the concavo-convex pattern P) was (outer radius ro of the master substrate 11) multiplied by (0.98 to 0.90).

For the master disk 10 having a nominal size of 1 inch, the outer radius Ri of the center-opening buffer region Bi (corresponding to the inner radius of the concavo-convex pattern P) was (radius ri of the center opening 11G) multiplied by (1.03 to 1.30), and the inner radius Ro of the outer-rim buffer region Bo (corresponding to the outer radius of the concavo-convex pattern P) was (outer radius ro of the master substrate 11) multiplied by (0.98 to 0.90).

For the master disk 10 having a nominal size of 0.85 inches, the outer radius Ri of the center-opening buffer region Bi (corresponding to the inner radius of the concavo-convex pattern P) was (radius ri of the center opening 11G) multiplied by (1.03 to 1.20), and the inner radius Ro of the outer-rim buffer region Bo (corresponding to the outer radius of the concavo-convex pattern P) was (outer radius ro of the master substrate 11) multiplied by (0.98 to 0.80).

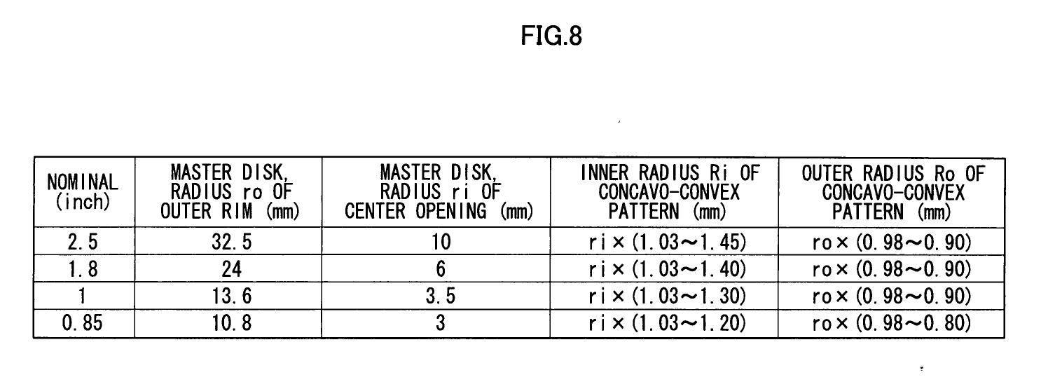

A list of these values is shown in FIG. 8. From the four master disks 10, servo information was magnetically transferred to a slave disk 14, and the quality of the signal reproduced with a reproducing head was evaluated.

If the inner radius Ri of the concavo-convex pattern P on the master disk 10 is too small, inadequate transfer which leads to reduction of the reproduced output or the like occurs due to the roll off DA at the center opening 11G. If the outer radius Ro of the concavo-convex pattern P on the master disk 10 is too large, inadequate transfer occurs due to the roll off DA at the outer rim 11H.

However, in any of the present examples in which, in the formula expressing the inner radius Ri of the concavo-convex pattern P: (the radius ri of the center opening 11G) multiplied by (a coefficient), the lower limit of the coefficient was 1.03, and in the formula expressing the outer radius Ro of the concavo-convex pattern P: (the radius ro of the outer rim 11H) multiplied by (a coefficient), the upper limit of the coefficient was 0.98, adequate magnetic transfer was achieved.

Furthermore, if the inner radius Ri of the concavo-convex pattern P is too large, the recording density of the slave disk 14, which is the target of magnetic transfer, as the magnetic recording medium is insufficient. Similarly, if the outer radius Ro of the concavo-convex pattern P is too small, the recording density of the slave disk 14, which is the target of magnetic transfer, as the magnetic recording medium is insufficient.

However, in any of the present examples in which, in the formula expressing the inner radius Ri of the concavo-convex pattern P: (the radius ri of the center opening 11G) multiplied by (a coefficient), the upper limit of the coefficient was 1.45, 1.40, 1.30 or 1.20 depending on the dimension of each master disk 10, and in the formula expressing the outer radius Ro of the concavo-convex pattern P: (the radius ro of the outer rim 11H) multiplied by (a coefficient), the lower limit of the coefficient was 0.90, 0.90, 0.90 or 0.80 depending on the dimension of each master disk 10, a sufficient recording density was assured.

As described above, according to the method of manufacturing a master disk for magnetic transfer according to the present invention, a center-opening buffer region is formed at the outer side of the surface of the master substrate relative to the region where a roll off occurs at the center opening of the master substrate, a concavo-convex pattern is formed at the outer side of the surface of the master substrate relative to the center-opening buffer region, and an outer-rim buffer region is formed at the inner side of the surface of the master substrate relative to the region where a roll off occurs at the outer rim of the master substrate, and the concavo-convex pattern is formed at the inner side of the surface of the master substrate relative to the outer-rim buffer region. Thus, the regions close to the roll-off parts at the center opening and the outer rim where magnetic transfer is unstable are not used, and only stable regions are used. Therefore, a master disk for magnetic transfer that can provide adequate magnetic transfer is obtained.

More specifically, the outer radius of the center-opening buffer region from the center of the center opening is determined as the radius of the center opening multiplied by a predetermined coefficient, and the inner radius of the outer-rim buffer region from the center of the center opening is determined as the outer radius of the master substrate multiplied by a predetermined coefficient. Thus, by appropriately setting the coefficients, the center-opening buffer region and the outer-rim buffer region can be made as narrow as possible, thereby achieving adequate magnetic transfer, while appropriately assuring a required recording density of information signals. In addition, using the master disk 10 thus manufactured, a high-quality magnetic recording medium can be obtained at low cost.

What is claimed is:

1. A method of manufacturing a master disk for magnetic transfer, comprising the steps of:
forming a metal plate having a predetermined thickness on an original plate having a concavo-convex pattern corresponding to information to be transferred;
stamping the metal plate separated from the original plate to form a center opening and a circular rim, thereby providing a master substrate; and
depositing a magnetic layer on the concavo-convex pattern of the master substrate,
wherein a region at the upper edge of the center opening where a roll off occurs when the center opening of the master substrate is formed by stamping is defined as a center-opening roll-off region, a predetermined range of center-opening buffer region is provided outside of the center-opening roll-off region, and the concavo-convex pattern is formed outside of the center-opening buffer region.

2. The method of manufacturing a master disk for magnetic transfer according to claim 1,
wherein a region at the upper edge of the outer rim where a roll off occurs when the outer rim of the master substrate is formed by stamping is defined as an outer-rim roll-off region, a predetermined range of outer-rim buffer region is provided at the inner side of the surface of the master substrate relative to the outer-rim roll-off region, and the concavo-convex pattern is formed at the inner side of the surface of the master substrate relative to the outer-rim buffer region.

3. The method of manufacturing a master disk for magnetic transfer according to claim 1,
wherein the outer radius of the center-opening buffer region from the center of the center opening is defined as a numeric value, which is the radius of the center opening multiplied by a predetermined coefficient.

4. The method of manufacturing a master disk for magnetic transfer according to claim 2,
wherein the outer radius of the center-opening buffer region from the center of the center opening is defined as a numeric value, which is the radius of the center opening multiplied by a predetermined coefficient.

5. The method of manufacturing a master disk for magnetic transfer according to claim 3,
wherein the predetermined coefficient for determining the outer radius of the center-opening buffer region has an upper limit and a lower limit.

6. The method of manufacturing a master disk for magnetic transfer according to claim 2,
wherein the inner radius of the outer-rim buffer region from the center of the center opening is defined as a numeric value, which is the outer radius of the master substrate multiplied by a predetermined coefficient.

7. The method of manufacturing a master disk for magnetic transfer according to claim 3,
wherein the inner radius of the outer-rim buffer region from the center of the center opening is defined as a numeric value, which is the outer radius of the master substrate multiplied by a predetermined coefficient.

8. The method of manufacturing a master disk for magnetic transfer according to claim 5,
wherein the inner radius of the outer-rim buffer region from the center of the center opening is defined as a numeric value, which is the outer radius of the master substrate multiplied by a predetermined coefficient.

9. The method of manufacturing a master disk for magnetic transfer according to claim 6,
wherein the predetermined coefficient for determining the inner radius of the outer-rim buffer region has an upper limit and a lower limit.

10. The method of manufacturing a master disk for magnetic transfer according to claim 7,
wherein the predetermined coefficient for determining the inner radius of the outer-rim buffer region has an upper limit and a lower limit.

11. The method of manufacturing a master disk for magnetic transfer according to claim 8,
wherein the predetermined coefficient for determining the inner radius of the outer-rim buffer region has an upper limit and a lower limit.

12. A master disk for magnetic transfer,
wherein the master disk is manufactured by the method of manufacturing a master disk for magnetic transfer according to claim 1.

13. A magnetic recording medium,
wherein the magnetic recording medium has pre-format information magnetically transferred from the master disk for magnetic transfer according to claim 12.
